(19) United States
(12) Patent Application Publication
(10) Pub. No.: US 2008/0298687 A1
(43) Pub. Date: Dec. 4, 2008

(54) Human image recognition system

(75) Inventors: Chin-Lun Lai, Jhonghe City (TW); Li-Shih Liao, Taoyuan Hsien (TW)

Correspondence Address: BACON & THOMAS, PLLC, 625 SLATERS LANE, FOURTH FLOOR, ALEXANDRIA, VA, 22314-1176, US

(73) Assignees: Chin-Ding Lai, Jhonghe City (TW); Chin-Lun Lai, Jhonghe City (TW); Hai-Chou Tien, Jhonghe City (TW); VANGUARD SECURITY ENGINEERING CORP., Taoyuan Hsien (TW)

(21) Appl. No.: 11/038,152

(22) Filed: Jan. 21, 2005

(30) Foreign Application Priority Data
Jan. 29, 2004 (TW) 093101967

(51) Int. Cl. G06K 9/00; G06K 9/68

(52) U.S. Cl. 382/218; 382/103

(57) ABSTRACT

The present invention is to provide a human image recognition system capable of determining a next movement of a person approaching a particular region of space, which comprises a determination unit adapted to determine whether there is a moving object in continuous images taken by an image taking unit by analyzing the continuous images. If yes, the determination unit compares the moving object with contours of at least one admissible person stored in a memory so as to determine whether the moving object is a person recognized or is about to enter into or leave from a door of a building by analyzing the person's moving direction and changed positions, and then determine whether the person should be allowed to pass through or not.

### FIELD OF THE INVENTION

The present invention relates to a human image recognition system, more particularly to a recognition system capable of determining whether to open a door in accordance with continuous images taken by a camera.

### BACKGROUND OF THE INVENTION

Image recognition systems for controlling entry of doors including automatic doors are well known. Such systems, as designed for security, prevention of burglary, entry management, and/or other purposes, have been widely installed in places including stores, department stores, houses, office buildings, no man banks, military facilities, and even toys. Typically, the image recognition systems are classified as detecting ones and sensing ones.

As for detecting system, it involves that a detecting member actively transmits signals in a form of or by means of laser, IR (infrared), ultrasonic waves, or radar to a reflecting object in an environment being detected. Signals reflected back from the object are then received by a receiver electrically coupled to the detecting member. The detecting member analyzes the strength and/or phase lags of the signals or the like for obtaining data including direction, size, and distance of the object by intensive calculation and activating subsequent procedures accordingly. As for sensing system, it involves that radiation from an object (e.g., IR waves transmitted from body temperature of a human being) can be sensed by a sensor for obtaining data including direction, size, and distance of the object through intensive calculation and activating subsequent procedures accordingly.

However, the installation of the detecting member and receiver in the detecting system not only increases system complexity and cost, but also causes erroneous results due to incorrect measurements and undesirable power consumption. As regards the IR based sensing system, it is not applicable for ordinary situations since its sensing accuracy and effectiveness mainly depend on factors including ambient temperature and percentage of the human body being exposed, etc., but irrelevant to its high expenditure. Thus, the need for improvement still exists.

### SUMMARY OF THE INVENTION

After considerable research and experimentation, a human image recognition system according to the present invention has been devised. The system incorporates a conventional camera and an image recognition mechanism such that recognizing an image taken by the camera to be an image of one of admissible persons will open a door for passing. The present invention is thus able to overcome the above drawbacks of the prior art.

It is an object of the present invention to provide a human image recognition system capable of determining a next movement of a person approaching a particular region of space. The system comprises an image taking unit and a determination unit. The image taking unit is a camera and is able to send taken images to the determination unit. The determination unit is a microprocessor or personal computer. The determination unit comprises a memory for storing a contour of at least one admissible person. The determination unit is thus adapted to determine whether there is a moving object in the continuous images taken by the image taking unit by analyzing the continuous image. If yes, the determination unit compares the moving object with the contour of each person stored in the memory so as to determine whether the moving object is a person or not. If yes, the determination unit determines whether the person is about to enter or leave the door of a building by analyzing the person's moving direction and changed positions. Moreover, the determination unit compares the image of the person with the image (i.e., the contour of each person) stored in the memory in order to determine whether the person should be allowed to pass through or not. Eventually, an enable signal is generated by the determination unit and is sent to a device to be operated (e.g., automatic door) for opening if the person is determined to be the admissible one.

The above and other objects, features and advantages of the present invention will become apparent from the following detailed description taken with the accompanying drawings.

### BRIEF DESCRIPTION OF THE DRAWINGS

FIG. 1 is a block diagram of a human image recognition system according to the invention;

FIG. 2 is a flow chart illustrating a process according to the invention; and

FIGS. 3 and 4 schematically depict human image recognition according to the invention.

### DETAILED DESCRIPTION OF THE PREFERRED EMBODIMENTS

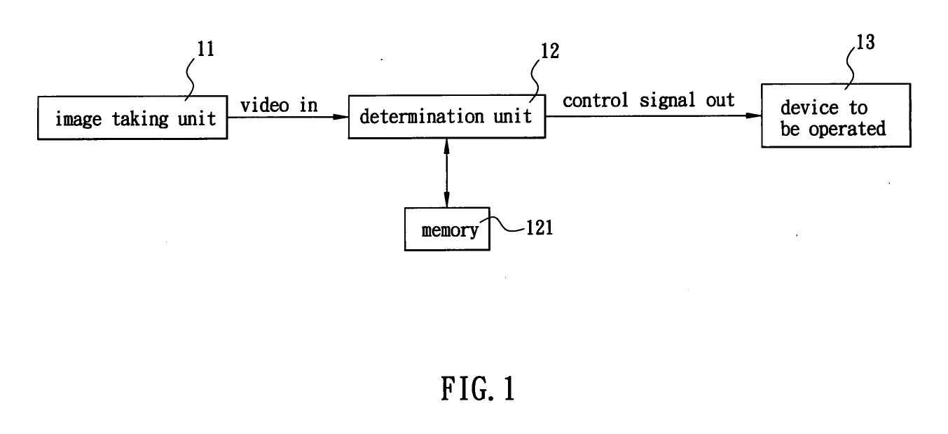

Referring to FIG. 1, there is shown a human image recognition system constructed in accordance with the invention comprising an image taking unit 11 and a determination unit 12. Each component will be described in detailed below. The image taking unit 11 is implemented as a camera such as CCD (charge coupled device) type camera, CMOS (complementary metal oxide semiconductor) type camera, or the like. Image taken by the image taking unit 11 is sent to the determination unit 12. The determination unit 12 is implemented as a microprocessor, personal computer, or digital signal processor. The determination unit 12 comprises a memory 121 for storing image of at least one admissible person. The image can be contour of a person, features of a specific person, etc. as contemplated by the invention. The determination unit 12 is adapted to determine whether an image taken by the image taking unit 11 is an image of one of admissible persons by comparing the taken image with the image stored in the memory 121. Moreover, the determination unit 12 is electrically coupled to a device (e.g., automatic door) 13 to be operated.

Referring to FIG. 1 again, by configuring as above the image taking unit 11 can continuously send taken images to the determination unit 12. The determination unit 12 then determines whether there is a moving object in the continuous images taken by the image taking unit 11. If yes, the determination unit 12 then compares the moving object with each human contour stored in the memory 121 so as to determine whether the moving object is a person or not. If yes, the determination unit 12 then determines whether the person is about to enter or leave the door of a building by analyzing his/her changed positions and moving direction thereof. Next, the determination unit 12 compares the image of the person with the images of admissible persons stored in the memory 121 in order to determine whether the person should be allowed to pass through or not. Eventually, an enable signal is generated and sent to the device 13 to be operated for opening if the person is determined to be the admissible one. For example, a door opening signal is generated and sent to a door for opening so as to permit the person to pass through the door.

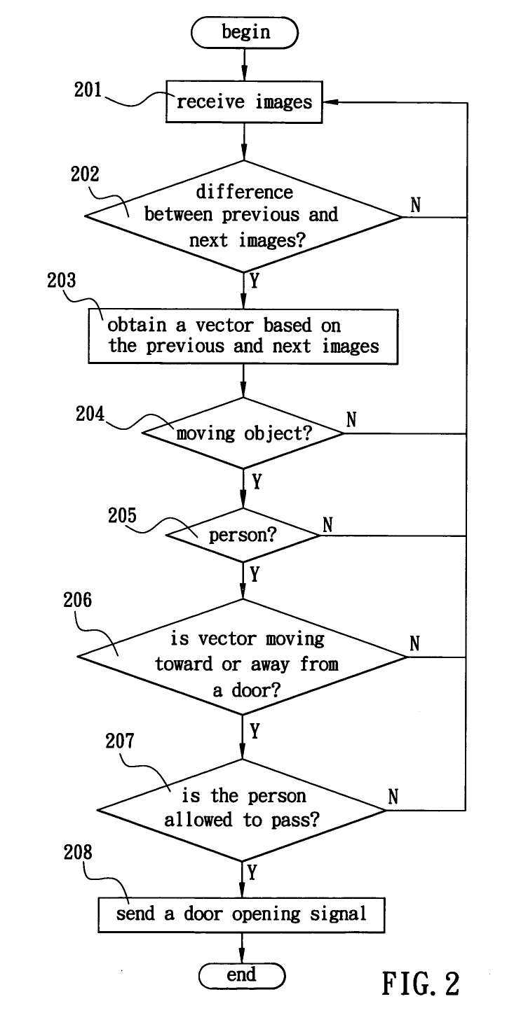

Referring to FIG. 2 in conjunction with FIG. 1, the determination unit 12 may perform the following steps in a process in response to activating the system according to the invention.

In step 201, receive images from the determination unit 12.

In step 202, compare a previous one of the images with an immediately next one thereof for determining whether there is any difference therebetween. If yes, the process goes to step 203. Otherwise, the process loops back to step 201.

In step 203, calculate the changed positions of the previous and next images and moving direction thereof for obtaining a vector of the images.

In step 204, it is determined whether there is a moving object in the continuous images (i.e., the previous and next images). If yes, the process goes to step 205. Otherwise, the process loops back to step 201.

In step 205, the moving object is compared with each human contour stored in the memory 121 so as to determine whether the moving object is a person or not. If yes, the process goes to step 206. Otherwise, the process loops back to step 201.

In step 206, it is determined whether the person is about to enter or leave the door of a building by analyzing the vector. If yes, the process goes to step 207. Otherwise, the process loops back to step 201.

In step 207, compares the image of the person with the images of admissible persons stored in the memory 121 in order to determine whether the person should be allowed to pass through or not. Moreover, it is determined whether the person is approaching the door or not. If yes, the process goes to step 208. Otherwise, the process loops back to step 201.

In step 208, a door opening signal is generated and sent to the door for opening such that the person can pass through the door prior to ending the process.

In the invention, the determination unit 12 may take two stages in determining the image signals sent by the image taking unit 11. First, obtain a difference between a previous image and an immediately next image for distinguishing a moving object from the static background. Next, obtain a next position of the moving object and calculate a moving direction and speed of the moving object by subtracting the origin of the next position of the moving object from the origin of the previous position thereof. It is thus possible of determining whether the person is about to enter or leave the door of a building by analyzing the moving direction and the speed change of the moving object (i.e., whether the moving object is approaching the origin of the image from left, right, or top). Next, it is determined whether the moving object is a person or not. The determination involves eliminating false signals, determining skin color, and determining facial complexion. Finally, it is determined whether the door should be opened or not. Note that the determination of human being is added only when entry management is required. Also, the time of opening the door will be determined by calculating moving direction and speed of the person. Moreover, the door opening instruction can be cancelled before the time of opening the door is reached in response to a moving direction change of the person (i.e., the person has changed mind).

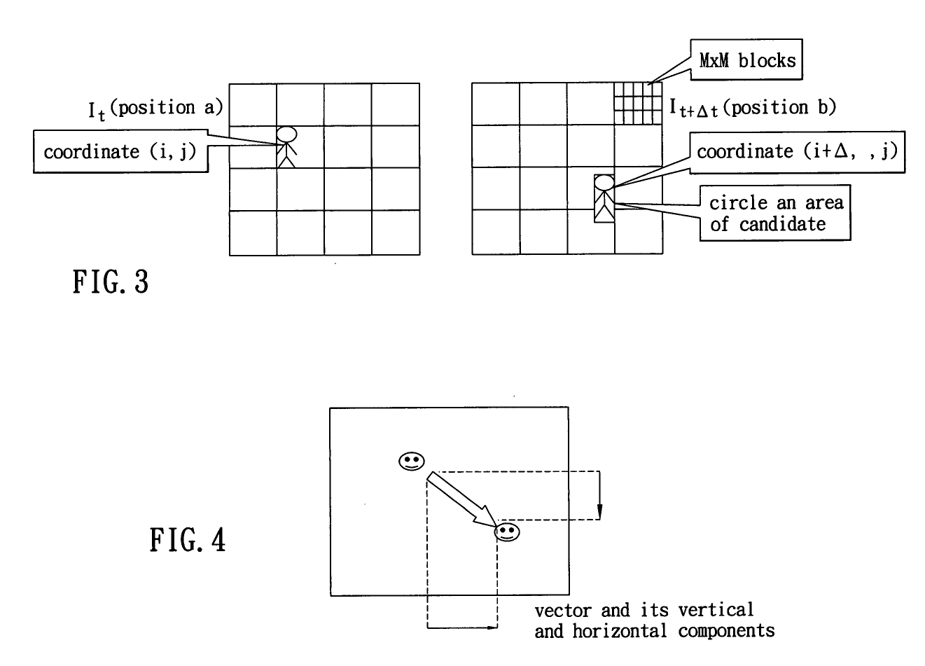

Referring to FIG. 3, at time t the moving object in an image Iₜ is located at a position as indicated by coordinate (i, j). At time t+Δt, the image I_{t+Δt} moves to another position as indicated by coordinate (i+Δ, j) in which each one of M×M blocks occupied by the image I_{t+Δt} is searched sequentially until a coordinate (i+Δ, j) is found where a minimum of Σ_{m,n=1:M}(|I_{t+Δt}(i+m+Δ, j+n)−Iₜ(i+m, j+n)|)/64 occurs. Δ is the difference of pixels. It(i+m, j+n) represents brightness of the image (i+m, j+n) at time t. In such a manner, vector of each pixel in the image can be obtained by calculation. A candidate can be found by circling an area occupied by vectors having the same direction. Referring to FIG. 4, the obtained vector and its vertical and horizontal components are analyzed for anticipating and evaluating the moving direction and speed of the moving object. As such, path of the moving object can be determined. Accordingly, it is possible of deciding whether the door should be opened or not.

In addition, the at least one image stored in the memory 121 of the determination unit 12 can be contour of a person such that it is possible of determining whether the moving object is a person or not.

Additionally, the at least one image stored in the memory 121 of the determination unit 12 can be features of a specific person such that it is possible of determining whether the moving object is the specific person or not.

In view of the above, the human image recognition system of the invention has the following advantages: i) It can substantially eliminate a drawback occurred in the prior device due to frequent false signals. For example, a door is opened simply because a small object (e.g., a small dog) is sensed by the prior IR based image recognition system installed in the door. ii) It can better understand changes of the environment for subsequent analysis of a sudden event by cooperating with a camera having recording feature. iii) It can achieve a tight security or is applicable in criminal investigation by cooperating with other recognition mechanisms (e.g., facial complexion recognition). iv) It has simple parts and is cost effective. For example, it can operate normally by cooperating with a simple CMOS type camera. v) It is highly adaptable to different applications by implementing a flexible algorithm.

While the invention herein disclosed has been described by means of specific embodiments, numerous modifications and variations could be made thereto by those skilled in the art without departing from the scope and spirit of the invention set forth in the claims.

What is claimed is:

1. A human image recognition system comprising:
an image taking unit for taking images; and
a determination unit for receiving the images from the image taking unit, the determination unit including a memory for storing image of at least one admissible person, the determination unit being adapted to determine whether the image taken by the image taking unit is an image of one of admissible persons by comparing the taken image with the image stored in the memory,
wherein the image taking unit is adapted to continuously send the taken images to the determination unit, the determination unit determines whether there is a moving object in the continuous images taken by the image taking unit, if yes then the determination unit compares the moving object with each image stored in the memory for determining whether the moving object is a person or not, if yes then the determination unit determines a movement of the person by analyzing a moving direction change of the person, and the determination unit either generates an enable signal if the person is determined to be the admissible one after comparing an image of the person with the image of each admissible person or not.

2. The system of claim 1, wherein the determination unit is electrically coupled to a device to be operated such that responsive to determining the moving object is a person the determination unit determines whether the person is about to enter or leave a door by analyzing the person's moving direction and changed positions, the determination unit compares the image of the person with the image of each admissible person stored in the memory for determining whether the person should be allowed to pass through or not, and an enable signal is generated by the determination unit and is sent to the device to be operated for opening if the person is determined to be the admissible one.

3. The system of claim 1, wherein the at least one image stored in the memory of the determination unit is the contour of a person such that the determination unit is adapted to determine whether the moving object is a person or not.

4. The system of claim 1, wherein the at least one image stored in the memory of the determination unit is the features of a specific person such that the determination unit is adapted to determine whether the moving object is the specific person or not.

5. The system of claim 1, wherein the image taking unit is a CCD type camera.

6. The system of claim 1, wherein the image taking unit is a CMOS type camera.

7. The system of claim 2, wherein the determination unit is a microprocessor.

8. The system of claim 2, wherein the determination unit is a personal computer.

9. The system of claim 2, wherein the device to be operated is an automatically operated door.
